(19) United States
(12) Patent Application Publication
(10) Pub. No.: US 2011/0312350 A1
(43) Pub. Date: Dec. 22, 2011

(54) MONITORING DEVICE AND SYSTEM

(75) Inventor: Soren Agerholm, London (GB)

(73) Assignee: AUTHENTICATED SECURE MESSAGING LIMITED, London (GB)

(21) Appl. No.: 13/201,438

(22) PCT Filed: Feb. 15, 2010
(86) PCT No.: PCT/GB2010/000262

§ 371 Date: Sep. 9, 2011

(30) Foreign Application Priority Data
Feb. 13, 2009 (GB) 0902378.9

(51) Int. Cl. H04W 4/14

(52) U.S. Cl. 455/466

(57) ABSTRACT

A stand-alone monitoring device and system are disclosed. The device comprises a mobile communication component operable to communicate over a communications network and a monitoring component, wherein the monitoring component is arranged to cause transmission of a message over said communications network to a predetermined recipient system via said mobile communication component upon detection of a predetermined condition or event.

### FIELD OF THE INVENTION

The present invention relates to a monitoring device and system that is particularly applicable in situations where low cost, simple security monitoring is desired and/or there is little or no ability to install cabling and other infrastructure to support the device.

### BACKGROUND TO THE INVENTION

Monitoring devices vary considerably in cost and in complexity. They range from basic audio baby monitoring systems to complex home or business alarm systems.

If you wish to install a security system to monitor your house or business, you are faced with a bewildering array of systems, all of which have different requirements and supporting infrastructures. Many people resort to professionally installed systems so that they have the reassurance that the system works correctly and that someone else is responsible for installation, configuration and cleaning up the mess.

Not only are professionally installed systems expensive, they also are normally complex and provide many more features than the average user will ever use (or be able to work out how to use). Additionally, there is a general premise in the industry that their systems should be scalable (able to cope with different sizes of installation). In order to address scalability, almost all systems operate via some central (either local or remote) server or hub.

There exist both cabled and wireless monitoring systems. Many today operate over Ethernet or a wireless standard such as IEEE 802.11. Some of the older systems operate over RF channels that actually overlap with the IEEE 802.11 channels and cause interference.

### STATEMENT OF THE INVENTION

According to an aspect of the present invention, there is provided a stand-alone monitoring device comprising a mobile communication component operable to communicate over a communications network and a monitoring component, wherein the monitoring component is arranged to cause transmission of a message over said communications network to a predetermined recipient system via said mobile communication component upon detection of a predetermined condition or event.

Preferably, the monitoring component includes a camera and the message includes an image associated with the condition or event captured by the camera and embedded within the message. Most preferably, the message comprises a multimedia message (MMS).

Preferably, the monitoring device is programmable from a remote device. Most preferably, the monitoring device is programmable via one or more short messaging service messages.

Preferably, the recipient system comprises a mobile telephone.

In preferred embodiments, a mobile telephone is usable to program the monitoring device either via direct SMS messages or through a provided user interface. Upon occurrence of a predetermined event or condition (such a timer triggering, detection of a heat source passing in front of an in built or external infra-red sensor, detection of a sound over a predetermined volume from an in built or external microphone . . . ), the monitoring component transmits data on the event or condition to the mobile telephone. Typically, the data on the event or condition is an image, image sequence (such as a series of MMS messages), video, audio stream, or some other captured data obtained by a component of the monitoring device (typically a camera of some description but could be or include some other component such as a microphone).

The mobile communication component may include (or include a simplified implementation of) a mobile telephone. It will be appreciated that other forms of communication components are also applicable such as email (over wireless network such as a GPRS, 3G or 802.11 network) and instant messaging, in which case the mobile communication component may be a mobile data network client, router, bridge or modem.

It will be appreciated that embodiments of the present invention offer many advantages. They will be relatively cheap to manufacture and implement compared to complex centralised server based systems; they can be easily installed without needing any complex wiring or other infrastructure; fixings are not necessary; they could run off battery power if necessary (and could have some form of sleep function coming out of dormant mode only upon detection of a condition/event); they can be portable and taken away on holiday etc and they are simple to program and control.

### BRIEF DESCRIPTION OF THE DRAWINGS

An embodiment of the present invention will now be described by way of example only with reference to the accompanying drawings, in which:

FIG. 1 is a schematic diagram of a monitoring device according to an embodiment of the present invention; and,

FIG. 2 is a schematic diagram of a monitoring system according to an embodiment of the present invention.

### DETAILED DESCRIPTION

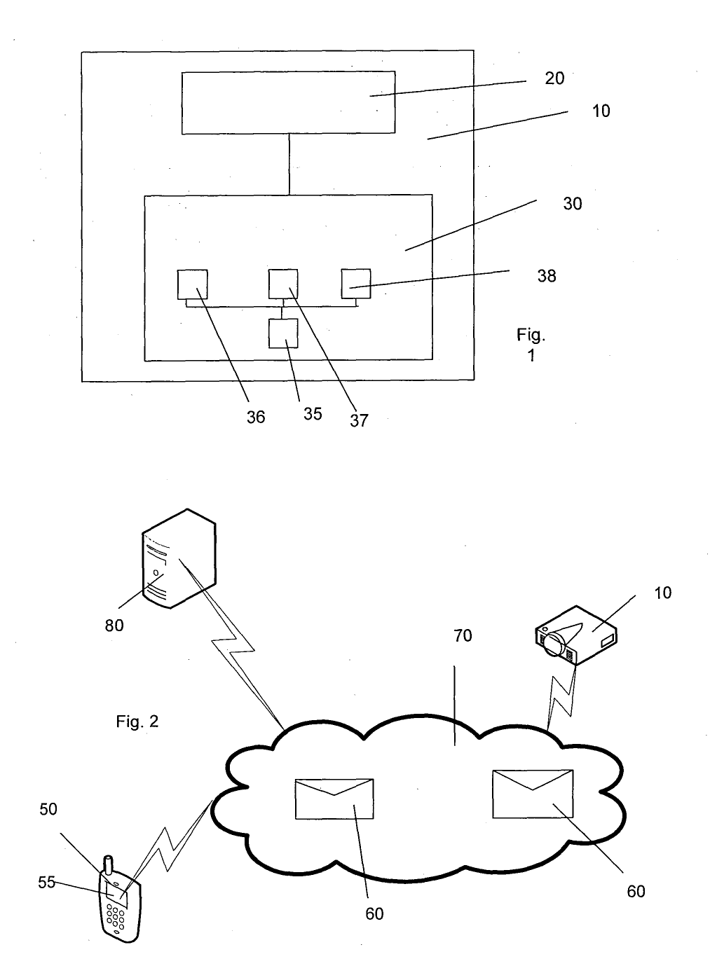

FIG. 1 is a schematic diagram of a monitoring device according to an embodiment of the present invention.

The monitoring device 10 includes a mobile communication component 20 and a monitoring component 30. The monitoring component 30 is arranged to cause transmission of a message to a predetermined recipient system via said mobile communication component 20 upon detection of a predetermined condition or event.

In a preferred embodiment, the monitoring component 30 includes a camera 35 and the message includes an image associated with the condition or event captured by the camera and embedded within the message. In a preferred embodiment, the mobile communication component 20 is a mobile telephony device. Preferably, the message comprises a multimedia message (MMS).

The monitoring component 30 may also include components such as an infra-red detector 36, a motion detector 37, a microphone 38 or the like for use in detecting the condition or event that triggers the message (discussed below).

FIG. 2 is a schematic diagram of a monitoring system according to an embodiment of the present invention.

The monitoring device 10 is programmable from a remote device 50 such as a mobile telephone, Smartphone, telephony enabled PDA or the like. Preferably, the monitoring device 10 is programmable via one or more short messaging service messages 60 transmitted over a mobile telephony network 70.

In preferred embodiments, the mobile telephone 50 is usable to program the monitoring device 10 either via direct SMS messages or through a user interface 55 provided for the mobile telephone 50 that then creates and transmits SMS messages to the monitoring device 10. Whilst it is preferred that SMS messages originate from the mobile telephone (so that it is paired with the monitoring device 10 for security and the monitoring device knows where to send alerts), it will be appreciated that this is not essential and a remote interface and/or system 80 could be accessed online or via some secure connection and used to generate and transmit the messages to the monitoring device 10.

Upon occurrence of a predetermined event or condition (such a timer triggering, detection of a heat source passing in front of an in built or external infra-red sensor, detection of a sound over a predetermined volume from an in built or external microphone . . . ), the monitoring component 30 transmits data on the event or condition to the mobile telephone 50. Typically, the data on the event or condition is an image, video or some other captured data obtained by a component of the monitoring device (typically the camera of some description but could be or include some other component such as the microphone). The monitoring device may optionally include an infra-red illumination system such that images can be captured in low-light or complete darkness.

Various possible implementation details are discussed below by way of example only:

### SMS Instructions

As discussed, the monitoring device 10 is preferably controlled by means of instructions sent via SMS from a mobile phone 50. Each message preferably consists of a combination of a command word and associated parameters. Approximately 30 command words are defined, but not all commands are available to all users. Each registered user has an authority level which determines which commands they are allowed to access.

A ‘registered user’ is a user whose profile exists in the monitoring device's internal user database. An unregistered user will be treated as a ‘Guest’ if security is OFF, or will be denied access if security is ON.

### SMS Format

The SMS Instruction messages preferably have a common format, as follows:

### <PIN> <COMMAND> <PARAMETER> <PARAMETER> <PARAMETER>

Each element of the Instruction is a group of letters and/or numbers (depending on context). Elements are separated by one or more spaces.

The <PIN> element is only required when the security mode is set to PIN. The command word <COMMAND> is mandatory. Most commands take either no parameters or one parameter. The maximum number of parameters is three.

### <PIN>

When Security Mode is set to PIN, it is necessary for every instruction to begin with the user's four-digit Personal Identification Number.

### <COMMAND>

The command word specifies what action is being requested. Each command word describes the function it invokes, e.g. ‘security’, ‘time’, ‘priority’, etc. For a command, it is only necessary to use the first three letters of the command word, (except ‘identity’ where ‘ID’ is acceptable) but using more letters, or even the full word, will not make any difference to the outcome.

For this reason, command words are shown below in a special way. The mandatory letters (usually the first three) are shown in capitals, and the rest of the word is shown in lower case. For example: PICture. It will be appreciated that other command formats are also possible and the present invention is not limited to the commands, their functions or the format in which they are conveyed to the monitoring device in this preferred embodiment.

Preferably, command words do not contain spaces or punctuation. When used in an SMS message, the case of the command word is unimportant.

### <PARAMETER>

Whether one or more parameters are required depends upon the command word.

The case of a parameter is generally unimportant, except where names are concerned. It is good practice to capitalise the first letter of names, although this is not mandatory. Names are stored as entered. Parameters cannot generally contain spaces or punctuation. An exception is the IDentity command, where the Identity of the Monitoring device can consist of up to three separate words separated by spaces.

### Non-Volatile Storage

The following data is preferably stored in the monitoring device 10 in permanent memory, and are not affected by the removal of power or a battery:
ID name of monitoring device
User profiles stored in database
Credit threshold
Light threshold
Battery threshold
Signal threshold
Camera delay
Wait time
Security mode
Image resolution
Mic sensitivity
Warning message status
Confirmation message status
Microphone Status
Disclose CLID status
Mains frequency

An internal clock requires power in order to keep time. A small internal backup battery maintains the power to run the clock for a few hours in the absence of a main battery. After this time the clock will stop and will need to be reset using either the TIMe, DATe, and ZONe commands or the SYNc command.

### Who Gets SMS Replies?

When a command SMS is sent to the Monitoring device, the destination of the reply depends upon the security settings, and whether Caller ID is supported and enabled.

### Security Mode OFF

The Monitoring device first checks whether a Caller ID number is present in the header of the command SMS. If so, the reply is sent to this number.

If the Caller ID number is found in the user database, the associated authority level is used to control the access rights.

If Caller ID is not available the user will be granted Guest access rights. A Guest can do everything an Owner can do except setting or changing the security mode.

Note that if Caller ID is not available, the only way the caller will receive a reply is if they use the ADD command to create a new entry in the user database giving their number.

### Security Mode PIN

The user is identified by his/her PIN. If they are authorised to access the Monitoring device (i.e. their PIN is found in the user database) the reply is sent to the caller ID number retrieved from the command SMS. If this is not present, then the reply goes to the number recorded in the user database for this user. If the user is found on the database, they are granted access rights according to their authority level. If they are not found, access will be denied. In this case, a message can be sent to Owners to notify them of an unauthorised access attempt.

### Security Mode CLId

The user is identified by their Caller ID. This is the number to which the reply is sent. If this is not present in the SMS header, then access will be denied. Otherwise the user will be granted access rights according to their authority level. If their number is not found in the database, access will be denied. In this case, a message can be sent to Owners to notify them of an unauthorised access attempt.

### Who Gets Pictures?

Each user is allocated a Priority number from 0 to 2. When a picture is triggered by motion detection, an image is immediately sent to users with Priority 1. If a read receipt is not received by the time set using the WAIT command, then Priority 2 users will be sent the same picture. Users whose Priority is set to 0 do not receive pictures triggered by motion detection.

Any authorised user can send the PIC command at any time to take a new picture. In this case the picture will be delivered to this user only, regardless of their Priority number. The same rules are used to determine the destination for these images as detailed in ‘Who gets SMS replies’.

If the PIC command is issued while the Monitoring device is waiting for a read receipt as a consequence of a motion-detection triggered event, the PIC command will cause a new picture to be taken, and attempts to send the previous image will be cancelled.

Detailed description of Commands

### Security

IDentity <name>

Sets or changes the device identity. This is a name which serves uniquely to identify the device, in order to distinguish it from others which may be in simultaneous use.

The command consists of at least the characters “ID” (case is not significant), followed by a space, and then the required name, e.g. “Lounge”, “Corridor 24”, “Car Park East”, etc.

The name may contain any combination of upper and lower case letters and numerals, from a single character up to a maximum of 20 characters, and can include up to 2 spaces.

Every message returned to the user will begin with “Id:” followed by this name, to identify the source of the message.

SECurity <mode>

Sets or changes the security mode. There are three modes, OFF, PIN and CLID. Please refer to the separate section on Security for details of this command.

PIN <nnnn>

Sets or changes a user's Personal Identification Number. This number is used, when the security mode is set to PIN, to identify the user. Please refer to the separate section on Security for details of this command.

CLId <on/off>

Determines whether or not the Monitoring device discloses its Caller ID or not.

### User Database

### ADD

The ADD command adds a new user to the user database. The command format is:
ADD <name> <authority> <number>

Parameters are not case sensitive, and must be separated by a single space, for example:
add john owner +441322350700
<name>
<name> is used to identify the user. It may contain any combination of upper and lower case letters and numerals (but not spaces) up to a maximum of 10 characters, for example:
john, JOHN1, 1234.
Names must be unique—no duplications are permitted.
<authority>
The user's authority level determines what facilities are available to them. Two authority levels are currently defined. These are OWNER and DEPUTY. Users with OWNER privileges have access to all user features, whereas those with DEPUTY privileges can receive pictures, but cannot change settings or otherwise control the Monitoring device.
<number>
This is the user's phone number. It may have up to 20 characters, and may not contain spaces or other punctuation. The number must be entered in international notation, starting with a ‘+’, for example:
+441322350700

### Error Messages:

| | |
|---|---|
| Invalid Parameter <name> | Name too long, already exists, |
| entry. | or no room for new |
| Invalid Parameter <authority> | Authority not recognised. |
| Invalid Parameter <number> | Number too long or already exists. |

### LISt

The LIST command will return a list of the current users. The command has no parameters, so the format is simply:
LIST

### PRIority

The PRIority command is used to change the order in which users receive pictures from the Monitoring device. Users with Priority 1 receive pictures first, followed by those with Priority 2, followed by those with Priority 3. Users having priority 0 do not receive pictures.

To change a user's priority, the command format is:
PRIority <name> <priority>
   where <priority> is a number between 0 and 3.

New users are allocated Priority 1 by default.

### Error Messages:

| | |
|---|---|
| Invalid Parameter <name> | Name too long or not recognised. |
| Invalid Parameter <priority> | Number out of range. |

### REMove

This command is used to remove a user from the database. The format is:
REM <name>

Since there must always be at least one user with OWNER authority, it is not possible to delete a sole owner.

### Error Messages:

Invalid Parameter <name> Name not found or name is sole owner

### Advisory Messages

WARnings <on/off>

Enables or disables Warning messages. The following Warning messages are affected:
Battery is low
Credit is low
Light is low
Signal is low

Reserve level messages are not affected.

CONfirmation <on/off>

Enables or disables Confirmation messages. Please refer to the Command List for details of which messages are affected by this command.

### Thresholds

CREdit <pppp>

Sets the credit threshold in pence. If the credit balance falls below this value, and Warnings are turned on, the ‘Credit is low’ message will be sent to all users who have been assigned priority level 1.

BATtery <nn>

Sets the battery threshold in percent. If the battery level falls below this value, and Warnings are turned on, the ‘Battery is low’ message will be sent to all users who have been assigned priority level 1.

LIGht <nn>

Sets the light threshold in percent. If the light level falls below this value, and Warnings are turned on, the ‘Light is low’ message will be sent to all users who have been assigned priority level 1.

SIGnal <nn>

Sets the signal threshold in percent. If the signal level falls below this value, and Warnings are turned on, the ‘Signal is low’ message will be sent to all users who have been assigned priority level 1.

### Clock

DATe <dd/MM/yy>

Sets the internal clock in the Monitoring device to the required date. The format of the date must be exactly as stated, or an Invalid Parameter message will result.

TIMe <hh:mm>

Sets the internal clock in the Monitoring device to the required time. The format of the time must be exactly as stated, or an Invalid Parameter message will result. Bear in mind that it will take a period of time for the message to reach the Monitoring device, depending on network traffic.

ZONe <+zz>

Sets the internal clock in the Monitoring device to the required time zone. The format of the date must be exactly as stated, or an Invalid Parameter message will result. Time zones are represented by signed number which represents units of 15 minutes. Thus to set the time zone to GMT −1 hour, the zone setting would be ‘−4’.

### SYNc

Sets the time, date, and zone automatically to the timestamp provided by the network (where available). The Monitoring device reads the timestamp from the SMS message containing the SYNc command, and sets its internal clock to this time. Bear in mind that the network timestamp corresponds to the time the message was sent, so it will not be perfectly accurate.

### Camera

CAMera <on/off>

Enables or disables motion detection. When the camera is off, it will not respond to motion. When it is on, the Monitoring device will detect motion, within its field of view, using its Passive Infra-Red sensor. This will cause the camera to take a picture and send it immediately to any user whose priority has been set to 1. If a read receipt has not been received after a set time (see WAlt command) then users with Priority 2 will be sent the same picture.

### PICture

Takes and sends a picture immediately. This command triggers the camera remotely, and returns the image to the user who sent the PICture command. Note that this command operates independently of Priority settings, and only the sender of the command will receive the image. Use of this command does not affect the CAMera state.

### RESolution <LOw/MED/HIgh>

Sets image resolution. The image resolution can be set to one of three settings, as follows:

| | |
|---|---|
| HIgh | 640 × 480 pixels |
| MEDium | 320 × 240 pixels |
| LOw | 160 × 120 pixels |

### FREquency <50/60>

Sets mains frequency in Hz. This enables the camera to scan at a rate appropriate for the local mains frequency, so as to avoid ‘strobing’ effects caused by flickering which is characteristic of AC lighting.

WAlt <mm>

Sets the time to wait (in minutes) before re-sending a picture. When a picture has been taken due to motion detection, it is immediately sent to users with priority 1. If a read receipt is not received within the time set, the same image will be sent to users with priority 2.

### Microphone

MICrophone <on/off>

Enables or disables the ability to monitor sounds local to the Monitoring device. When enabled, a voice call to the unit from an authorised user will be accepted after the first ring. The microphone will then enable the user to monitor sounds in the vicinity of the unit. To end the call, the user simply hangs up in the normal way. If this feature is disabled, the monitoring device will not accept voice calls, and consequently the caller will receive ring tone.

This feature is not compatible with PIN security mode, since the acceptance or otherwise of the call depends on Caller Id verification. Hence it will only work with security OFF (anyone can listen in) or CLID mode (only registered users with sufficient authority can listen).

SENsitivity <n>

Sets the microphone sensitivity. The sensitivity of the microphone determines how much amplification is applied to the sound. In noisy environments it may be desirable to reduce the sensitivity to allow greater clarity of sound. When used in quiet surroundings, a higher sensitivity may be, appropriate, which may enable more distant sounds to be captured.

### Information

INFormation <topic>

Information messages can be requested by sending this command. If the command is issued with no topic, a list of topics will be returned. The available topics are:
CLOck
OPerational
SETtings
VALues
INFormation CLOck
Lists the commands used to set the time.
INFormation Operational
Lists operational parameters, such as the camera and microphone status.
INFormation SETtings
Lists current settings, e.g. picture resolution, microphone sensitivity.
INFormation VALues
Lists current values of battery, credit, light, and signal, together with their corresponding thresholds.

### Help

HELp <topic>

Help messages can be requested by sending this command. If the command is issued with no topic, a list of topics will be returned. The available topics are:
HELp ADVisory
HELp CAMera
HELp CLOck
HELp INFo
HELp MICrophone
HELp SECurity
HELp THResholds
HELp USErs
HELp ADVisory

Provides help on Warning and Conformation messages,

### HELp CAMera

Provides help on camera related commands.

### HELp CLOck

Provides help on commands used to set time, date and zone.

### HELp INFo

Provides help on Information messages.

### HELP MICrophone

Provides help on commands related to the Microphone.

### HELp SECurity

Provides help on security related commands.

### HELp THResholds

Provides help on setting thresholds for values which may trigger Warning messages.

### HELp USErs

Provides help on User Access commands.

### Information Messages

INFo—Information message menu

### Id: Software Laboratory

### INFo CLOck

### INFo OPerational

### INFo SETtings

### INFo VALues

81 characters

### INFo CLOck—Clock

### Id: Software Laboratory

### Date: 18/12/08

### Time: 17:27:55

### Zone: +00

66 characters
INFo OPerational—Operational parameters

### Id: Software Laboratory

### Camera: OFF

### Confirm: ON

### Disclose CLID: OFF

### Mic: OFF

### Security: OFF

### Warnings: OFF

109 characters

### INFo SETtings—Settings

### Id: Software Laboratory

### Delay: 3s

### Freq: 50 Hz

### Res: LOw

### Sens: 5

65 characters

### INFo VALues—Current Values

### Id: Software Laboratory

### Battery: 85%

### Threshold: 20%

### Credit: 2345 p

### Threshold: 500 p

### Light: 34%

### Threshold: 10%

### Signal: 36%

### Threshold: 30%

142 characters
Monitoring device Help Messages

### HELp

### Id: Software Laboratory

### HELp ADVisory

### HELp CAMera

### HELp CLOck

### HELp INFo

### HELp MICrophone

### HELp SECurity

### HELp THResholds

### HELp USErs

### HELp ADVisory

### Id: Software Laboratory

### WARnings <ON/OFF>

Warning messages

### CONfirmation <ON/OFF>

Confirmation messages

### HELp CAMera

### Id: Software Laboratory

CAMera <on/off>
Enables camera

### PICture

Takes a picture

### RESolution <LOw/MEDium/HIgh>

Sets picture resolution

### FREquency <50/60> Hz

### Sets Mains Frequency

### HELp CLOck

### Id: Software Laboratory

DATe <dd/MM/yy>
Sets date
TIMe <hh:mm>
Sets time
ZONe <+zz>
Sets time zone

### SYNc

Sets time/date
automatically

### HELp INFormation

### Id: Software Laboratory

INFormation <topic>
Information messages

### Tip: Send INFormation for

a list of topics

### HELp MICrophone

### Id: Software Laboratory

### MICrophone <ON/OFF>

### Enables Microphone

### SENsitivity <1.9>

### Sets Sensitivity

### HELp SECurity

### Id: Software Laboratory

### SECurity <OFF/PIN/CLID>

Sets Security mode
PIN <name> <nnnn>

### Changes PIN

### CLId <ON/OFF>

### Discloses Caller ID

### HELp THResholds

### Id: Software Laboratory

CREdit <pppp>
Sets credit threshold pence
BATtery <nn>
Sets battery threshold %
LIGht <nn>
Sets light threshold %
SIGnal <nn>
Sets signal threshold %

### HELp USErs

### Id: Software Laboratory

IDEnt <name>
Changes device name
ADD <name authority pin/phone>
Adds a user
REMove <name>
Removes a user

### LISt

Lists current users

### Error Message

### Id: Software Laboratory

### Help Unavailable

Additional Features for Monitoring device

### Credit Balance

The Monitoring device may use a pay-as-you-go SIM card. From time to time you will need to top this up by telephone, online, or by using a top-up card.

### Setting the Credit Threshold

Set the credit threshold by using the CREdit command. Note that the credit balance is expressed in pence. For example:
CREdit 150
   will set the threshold to 150 p (i.e. £1.50). There must be a space between the command and the number. Do not enter any spaces or punctuation (e.g. comma or decimal point) in the number. The credit threshold can by any number of pence between 1 and 9,999 (E99.99).

The default credit threshold is 100 p (£1.00). Set the threshold to 0 to disable this function.

### Finding Out Your Credit Balance

You can find out what your credit balance is at any time by sending the INFo VALues command to the Monitoring device like this:
INFo VALues

The Monitoring device will reply with a text message containing a list of information, including your current balance. If Confirmations are ON, you will receive this message automatically if you change the credit threshold.

If the credit balance falls below the set threshold, the Monitoring device will send a text message stating ‘Credit is low’.

If a picture is received while the credit is below the threshold, the text ‘Credit Low’ will accompany the picture.

### Light Level

The ambient light level is continuously monitored by the Monitoring device. If the level goes too low, the quality of the picture may be compromised.

### Setting the Light Threshold

Light level is expressed as a percentage, 0% being complete darkness, and 100% being extremely bright. Set the light threshold by using the LIGht command, for example:
LIGht 20
   will set the threshold to 20%. There must be a space between the command and the number. Do not enter any spaces or punctuation (e.g. decimal point) in the number. The light threshold can be any number between 1 and 99. The default light threshold is 10%. Set the threshold to 0 to disable this function.

Finding Out the Current Light Level

You can find out what the light level is at any time by sending the INFo VALues command to the Monitoring device like this:
INFo VALues

The Monitoring device will reply with a text message containing a list of information, including the current light level. If Confirmations are ON, you will receive this message automatically if you change the light threshold.

If the light level falls below the set threshold, the Monitoring device will send a text message stating ‘Light is low’. No further warning messages regarding the light level will be sent until the light level has increased to at least 10% above the set threshold

If a picture is received while the light is below the threshold, the text ‘Light Low’ will accompany the picture.

### Battery Level

The monitoring device is preferably powered by a self-contained battery, which will need to be charged from time to time. The state of charge of the battery is continuously monitored by the Monitoring device. If the level goes too low, the unit will automatically switch off to protect the battery. It may optionally provide a warning message to a predetermined recipient.

### Setting the Battery Threshold

Battery level is expressed as a percentage, 0% being completely flat, and 100% being fully charged. Set the battery threshold by using the BAT command, for example:
BAT 30
   will set the threshold to 30%. There must be a space between the command and the number. Do not enter any spaces or punctuation (e.g. decimal point) in the number. The battery threshold can by any number between 1 and 99. The default battery threshold is 20%. Set the threshold to 0 to disable this function.

### Finding Out the Current Battery Level

You can find out what the battery level is at any time by sending the INFO command to the Monitoring device like this:
INFO

The Monitoring device will reply with a text message containing a list of information, including the current battery level. If Confirmations are ON, you will receive this message automatically if you change the battery threshold.

If the battery level falls below the set threshold, the Monitoring device will send a text message stating ‘Battery is low’. No further warning messages regarding the battery level will be sent until the battery has been charged to at least 10% above the set threshold.

If a picture is received while the battery is below the threshold, the text ‘Battery Low’ will accompany the picture.

### Signal Level

The monitoring device preferably communicates via a GSM, GPRS, 3G, 4G or CDMA network, like a conventional mobile phone. The ability of the Monitoring device to communicate is therefore dependant upon the signal received from the network being sufficiently strong. The level of the signal is continuously monitored by the Monitoring device. If the level goes too low, the unit will not be able to communicate effectively.

### Setting the Signal Threshold

Signal level is expressed as a percentage, 0% being no signal, and 100% being maximum signal. Set the signal threshold by using the SIG command, for example:
SIG 50
   will set the threshold to 50%. There must be a space between the command and the number. Do not enter any spaces or punctuation (e.g. decimal point) in the number. The light threshold can by any number between 1 and 99. The default signal threshold is 30%. Set the threshold to 0 to disable this function.

### Finding Out the Current Signal Level

You can find out what the signal level is at any time by sending the INFO command to the Monitoring device like this:
INFO

The Monitoring device will reply with a text message containing a list of information, including the current signal level. If Confirmations are ON, you will receive this message automatically if you change the signal threshold.

If the signal level falls below the set threshold, the Monitoring device will send a text message stating ‘Signal is low’. No further warning messages regarding the signal level will be sent until the signal level has recovered to at least 10% above the set threshold.

If a picture is received while the signal is below the threshold, the text ‘Signal Low’ will accompany the picture.

1. A stand-alone monitoring device, comprising;
a mobile communication component operable to communicate over a communications network; and
a monitoring component,
wherein the monitoring component is arranged to cause transmission of a message over said communications network to a predetermined recipient system via said mobile communication component upon detection of a predetermined condition or event.

2. A stand-alone monitoring device according to claim 1, wherein the mobile communication component comprises a mobile telephony system and the communications network comprises a mobile telephone network.

3. A stand-alone monitoring device according to claim 2, wherein the message comprises a multimedia message (MMS).

4. A stand-alone monitoring device according to claim 2, wherein the mobile communication component comprises a limited functionality mobile telephone.

5. A stand-alone monitoring device according to claim 1, wherein the monitoring component includes a camera and the message includes an image associated with the condition or event captured by the camera and embedded within the message.

6. A stand-alone monitoring device according to claim 1, wherein the mobile communication component is arranged to receive commands from a predetermined command set via the mobile communication component.

7. A stand-alone monitoring device according to claim 6, wherein the monitoring device is arranged to execute commands in a short messaging service message received by the mobile communication component.

8. A stand-alone monitoring device according to claim 7, wherein the monitoring device is arranged to execute one of at least a subset of the predetermined command set if it is received via an SMS message from a predetermined mobile telephone number.

9. A stand-alone monitoring device according to claim 1, wherein upon occurrence of the predetermined event or condition, the monitoring component is arranged to transmit the message including data on the event or condition to the predetermined recipient.

10. A stand-alone monitoring device according to claim 9, wherein the data on the event or condition is selected from an image, an image sequence, a video and an audio stream.

11. A stand-alone monitoring device according to claim 1, further comprising a battery power source for powering the monitoring device.

12. A stand-alone monitoring device according to claim 1, wherein the monitoring device includes a reduced power operation mode in which predetermined components of the monitoring device are maintained in a dormant or off state until detection of a condition or event.

13. A stand-alone monitoring device according to claim 12, wherein the monitoring device is arranged to place the predetermined components in the dormant or off state after a predetermined time has elapsed since the last detection of a condition or event.

14. A method for monitoring for events or conditions at a location comprising:
installing a stand-alone monitoring device according to any preceding claim at the location;
transmitting a short messaging service message to the stand-alone monitoring device specifying a mobile telephone number to report to; and
receiving a report from the stand-alone monitoring device at the mobile telephone number upon occurrence of a condition or event.
